(19) United States
(12) Patent Application Publication
(10) Pub. No.: US 2012/0001434 A1
(43) Pub. Date: Jan. 5, 2012

(54) METHOD AND APPARATUS FOR GENERATION OF FREE-SURFACE WAVES USING CAVITY RESONATOR

(76) Inventor: Peter Oshkai, Victoria (CA)

(21) Appl. No.: 13/175,775

(22) Filed: Jul. 1, 2011

Related U.S. Application Data
(60) Provisional application No. 61/361,236, filed on Jul. 2, 2010.

(51) Int. Cl. F03B 17/06

(52) U.S. Cl. 290/54

(57) ABSTRACT

A wave generation device includes a main flow channel and one or more side channels to initiate vortex shedding and generate a resonant free-surface standing wave. The main channel is a duct for the passage of a fluid such as water. The side channel or channels can be perpendicular or parallel to the main channel. Operation of the wave generation device relies on the exchange of energy between the unsteady vorticity-bearing flow in the main channel across the opening of the side channel cavity and the velocity field due to the resonant standing wave that forms in said cavity. The incoming flow of the main channel causes a cross-flow fluctuation in the separating shear layer as it is disturbed at the leading corner of the side channel, which is amplified in the streamwise direction. This fluctuation resonates within the side channels, generating the standing wave. The amplitude and power capacity of the resonant standing wave is determined by the incoming flow velocity, incoming flow depth, and side channel width.

### CROSS REFERENCE TO RELATED APPLICATION

This application claims the benefit of U.S. Provisional Application 61/361,236, filed Jul. 2, 2010, which is incorporated herein by reference.

### FIELD

The present invention provides devices and methods of use thereof in the generation of free-surface waves, using a wave cavity resonator constituting a main channel and one or more side channels. This invention provides a standing wave generation device such that the wave motion can be harnessed for the generation of electricity from a fluid flow.

In addition, this device can be used in applications where free-surface undulations are beneficial for water aeration and mixing, such as fisheries, waste water treatment facilities or bioreactors. The dimensions of the side cavity, or cavities, can be adjusted based on the flow conditions (velocity, roughness of the walls, and water depth) in the main channel to provide the desired level of entrainment of the fluid from the main channel into the cavity as well as the desired mean residence time of a typical fluid particle within the cavity.

### BACKGROUND

Operation of the present invention relies on the energy exchange between unsteady vorticity-bearing flow across the opening of a cavity and the velocity field due to the resonant standing wave that forms in the cavity. A conceptual framework for the generation of the resonant, or locked-on, velocity field requires consideration of strictly hydrodynamic flow oscillations without resonance. These concepts are discussed in detail by Rockwell et al. [1]1. Rockwell, D., Lin, J. C., Oshkai, P., Reiss, M., and Pollack, M., Shallow cavity flow tone experiments: onset of locked-on states. Journal of Fluids and Structures 2003. 17(3): p. 381-414.

The basic elements of the self-sustained flow oscillations have been described by Rockwell [2], Blake [3], and Howe [4], among others, for a variety of systems that involve separated shear layers and their impingement on downstream structural features. 2. Rockwell, D. and E. Naudascher, Self-sustained oscillations of impinging free shear layers. Annual Reviews of Fluid Mechanics, 1979(11): p. 67-94.3. Blake, W. K., Mechanics of Flow-Induced Sound and Vibration. 1986, New York: Academic Press.4. Howe, M. S., Theory of Vortex Sound. 2003: Cambridge University Press.

The case of flow oscillations in the presence of a resonator, which occurs in many engineering systems, is particularly relevant to the present invention. Common configurations include flow past a cavity in the presence of an acoustic resonator, such as a long pipe, jet excitation of a long organ pipe, jet flow past a sequence of orifice plates, wake of a flat plate in a duct, and flow past an acoustically-resonant cavity. In these systems, resonance, or lock-on, occurs between the hydrodynamic flow oscillations illustrated in FIG. 1 and one or more modes of the resonator.

Acoustically-coupled shear layer oscillations in a system that involves flow past a rectangular cavity (side branch) have been characterized both theoretically and experimentally by Bruggemann et al. [5] and Kriesels et al. [6] In addition, Dequand et al. [7] provided an overview of numerical and theoretical approaches to estimation of the amplitude of acoustic displacement and visco-thermal damping in acoustically-coupled side branches. More recently, Oshkai et al. [8] outlined a semi-empirical approach of the characterization of the spatial structure of the acoustic source region, which involves quantitative imaging of the acoustically-coupled flow using particle image velocimetry (PIV). 5. Bruggeman, J. C., et al., Self-sustained aero-acoustic pulsations in gas transport systems: experimental study of the influence of closed side branches. Journal of Sound and Vibration, 1991. 150: p. 371-393.6. Kriesels, P. C., et al., High-amplitude vortex-induced pulsations in a gas transport system. Journal of Sound and Vibration, 1995. 184: p. 343-368.7. Dequand, S., Hulshoff, S. J., Hirschberg, A., Self-sustained oscillations in a closed side branch system. Journal of Sound and Vibration, 2003. 263: p. Journal of Sound and Vibration.8. Oshkai, P., et al., Acoustic Power Calculation in Deep Cavity Flows. Journal of Fluids Engineering, 2008. 130(051203-1).

Flow-acoustic coupling in a main duct-side branch system shares several conceptual similarities with the generation of standing waves (seiching) in water reservoirs by a grazing flow past the entrance to the reservoir, as described by Rockwell [9]. Particularly relevant is an experimental investigation of Ekmekci et al. [10] of a resonant coupling of a flow past a side branch with a standing gravity wave. The authors applied PIV to characterize various degrees of shear layer-wave coupling in terms of evolution of vortical structures along the mouth of the side branch. 9. Rockwell, D., Vortex formation in shallow flows. Physics of Fluids, 2008. 20.10. Ekmekci, A. and D. Rockwell, Oscillation of shallow flow past a cavity: Resonant coupling with a, gravity wave. Journal of Fluids and Structures, 2007. 23(6): p. 809-838.

Unlike the prior art, the present invention discloses the use of wave-flow coupling in a main duct-side branch system to generate standing free-surface waves from a fluid flow for the purpose of generating electricity. In addition, other potential applications of the generated standing waves include aeration in natural and artificial reservoirs and estuaries and controlled flow circulation in water treatment facilities or bioreactors.

### SUMMARY

The present invention is directed to apparatus and methods of operation that are further described in the Brief Description of the Drawings, the Detailed Description, and the claims. Other characteristics and advantages of the present invention will become evident from the following detailed description of the invention made with reference to the accompanying drawings.

### BRIEF DESCRIPTION OF THE DRAWINGS

FIG. 1 is a schematic view illustrating flow in a main channel that produces vortex induced pulsations in a side channel or cavity.

FIG. 2 is a perspective view showing a main flow channel and a side channel having coaxial side branches situated on opposing sides of the main channel.

FIG. 3 is a plan view of a main channel that is serially coupled to first and second free-surface coaxial side branch resonators. Fluid dynamic effects occur at a leading corner and at trailing corners of the side cavities or channels 324 such that a resonant velocity field is generated.

FIG. 4 illustrates a method of extracting energy from and controlling phase and amplitude of vortex-induced free surface oscillations in a side channel produced by flow in a main channel.

FIG. 5A is a plan view of an energy extractor that includes a main channel coupled to a side channel, wherein both the main channel and the side channel extend along a common direction.

FIG. 5B is a plan view of an energy extractor that includes a main channel coupled in series to two side channels, wherein both the main channel and the side channels are perpendicular and the side channels are situated on the same side of the main channel.

FIG. 5C is a plan view of an energy extractor that includes a main channel coupled to two oppositely situated side channels, wherein both the main channel and the side channels extend along a common direction.

FIG. 5D is a plan view of an energy extractor that includes a main channel coupled to a curved side channel.

FIG. 6A is a plan view of an energy extractor that includes a fluid flow in a large body of water coupled to a cavity in a Helmholtz resonator configuration.

FIG. 6B is a plan view of an energy extractor that includes a main channel coupled to a side cavity in a Helmholtz resonator configuration.

FIG. 6C is a plan view of an energy extractor that includes a main channel coupled to a series of adjacent side cavities.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

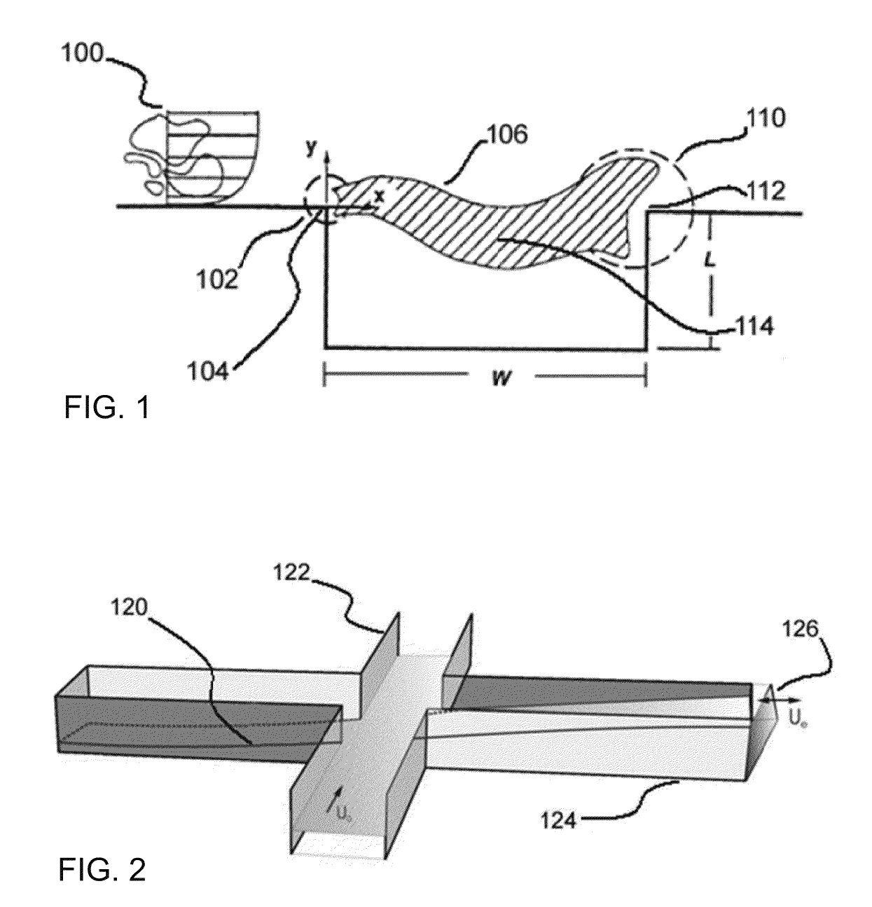

A novel free-surface wave cavity resonator apparatus for generating free-surface waves and harnessing the wave motion for the generation of electricity is presented herein. Features of the self-sustained flow oscillations in the presence of a rectangular cavity are shown in FIG. 1. When the fully-turbulent inflow flows past a blunt object, such as the corner of a channel, the original upstream disturbance is converted to a cross-flow fluctuation in the separating shear layer, which is subsequently amplified in the streamwise direction. The associated vortical structures interact with the downstream corner of the cavity, thus providing an upstream influence for the sensitive region at the leading corner of the cavity. Due to the dimensions of the cavity, these alternating vortices oscillate at a resonant frequency of the apparatus, and contribute to increasing amplitudes of the free-standing waves that are produced in the cavity. A float, piston or plunger system deployed in the cavity, preferably at the end of the cavity opposite to its opening, can be used to harness and control the waves for the production of electricity. The referred location of the energy converter is determined by the position of the antinodes of the resonant standing wave.

The present invention is expected to compete with conventional turbine-based hydroelectric technology in the low-power range. One representative advantage in some embodiments is the ability to be used in situations where deployment of turbines is not practical, i.e. in shallow rivers/channels that cannot be dammed or diverted due to environmental or economic constraints.

Unlike traditional hydroelectric facilities, which involve installation of dams and flooding of large areas of land, the disclosed embodiments generally do not require alteration of the flow in the river/channel, which tends to reduce the negative impact on fish and wildlife habitat.

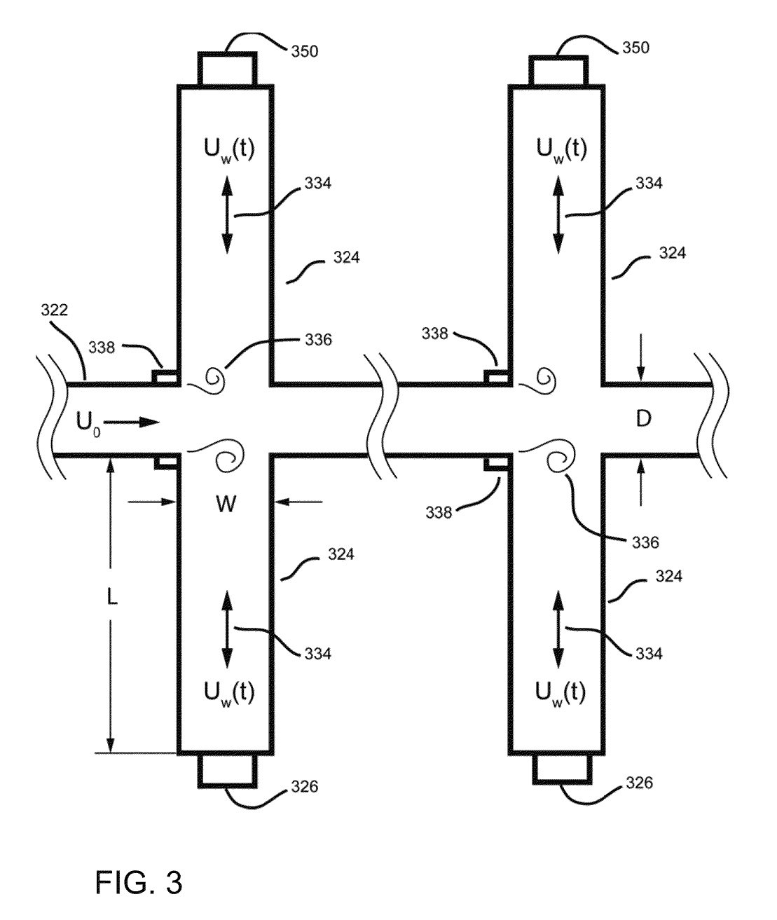

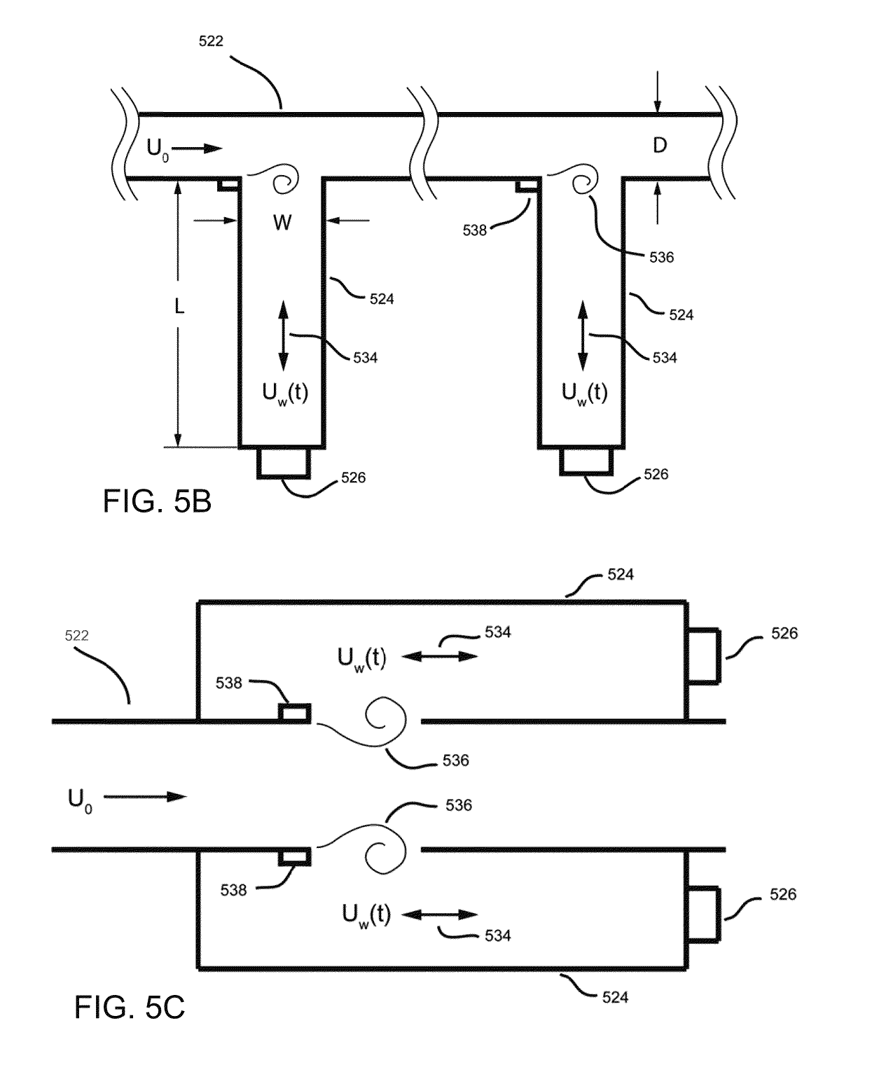

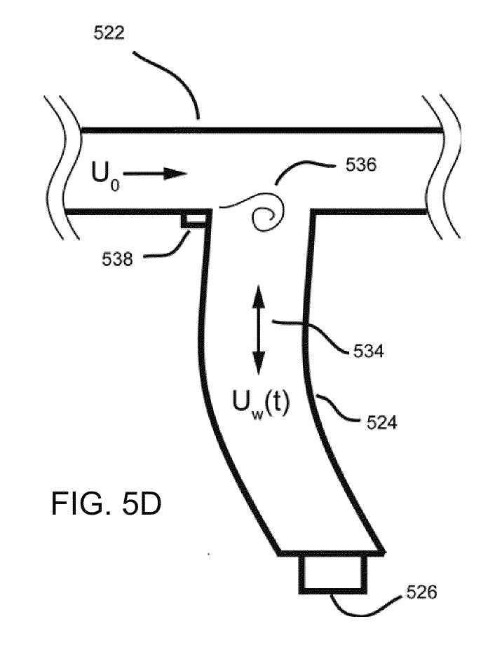

A preferred coaxial configuration shown is shown in FIG. 3 and alternative configurations that involve a single cavity are shown in FIG. 5. Moreover, several devices can be deployed in series to increase power output. Those skilled in the art will understand that a variety of configurations can be implemented.

The device will operate in a stream of water and will convert the energy of the uniform flow into the oscillatory motion of the water surface in the resonating cavity (side branch) configuration. The energy of the standing free waves in the side branches can be subsequently converted to electricity.

In one embodiment, this invention provides a device and methods of use thereof for the generation of free-surface waves, using a wave cavity resonator constituting a main channel and one or more side channels.

In another embodiment, the invention provides a wave energy generation device comprising:
a main channel;
one or more side channels;
a unit to capture kinetic energy of the waves in the side channels and convert it into electricity;
wherein the side channels are perpendicular or parallel to the main channel.

For convenient illustration of the disclosed technology, FIG. 1 is provided to illustrate the fluid dynamics involved in the present invention. The main channel carries a steady, uniform, turbulent or laminar inflow 100 with a velocity U₀, which passes over the opening of the cavity. As the flow separates from the upstream corner 104 of the cavity, vortices are formed periodically in the opening region 106. The frequency of vortex shedding is determined by the thickness of the boundary layer that develops along the wall of the main channel and the width of the side branch W [11]. 11. Oshkai, P., D. Rockwell, and M. Pollack, Shallow Cavity Flow Tones: Transformation from Large-to Small-Scale Modes. Journal of Sound and Vibration, 2005. 280(3-5): p. 777-813.

The vortices are convected along the opening of the side branch 114 and eventually interact with the downstream corner 112 in a surrounding region 110, creating periodic pressure pulsations. The pressure pulsations, in turn, result in formation of a free-surface wave that travels along the side branch and impinges on its closed end. Combination of the incident and the reflected waves creates a standing wave in the side branch. The natural frequency of the standing wave oscillation is determined by the length of the side branch L [12]. 12. Oshkai, P. and T. Yan, Experimental Investigation of Coaxial Side Branch Resonators. Journal of Fluids and Structures, 2008. 24(4): p. 589-603.

If the frequency of the vortex shedding at the side branch opening matches the natural frequency of the standing free-surface wave, part of the energy of the wave is used to increase circulation of the vortices, which in turn increases the magnitude of the pressure pulsations and the amplitude of the standing wave. This condition corresponds to the flow-wave resonance. When resonance occurs, the vortices in the branches of the present invention are formed with the same frequency, but out-of-phase with each other. Likewise, the standing waves in the side branches have the same frequencies but opposite phases [12].

FIG. 2 is a perspective view illustrating a representative flow channel configuration according to a representative embodiment of the device. Two deep cavities 124, or side branches, are located on the opposite sides of a main channel 122 and are situated in-line with each other. Water inflows at a velocity U₀ and generates a standing wave with a free surface 120. Part of the energy of the standing water wave is subsequently converted to electricity by a piston-type wave energy converter 126 deployed at a closed end of one of the side branches. Another conventional type of wave energy converter (i.e. paddle, plunger or floating body type) can also be used instead of or in addition to the convertor 126.

FIG. 3 illustrates a plan view of the two devices such as those of FIG. 2 arranged about a common flow channel 322 (the main channel). Two deep cavities 324, or side branches, are located on the opposite sides of the main channel 322 and in-line with each other. Water inflows at U₀ and causes vortices 336 to form at channel edges between the main channel and the side branches, and in turn generates a standing wave 334 that propagates along a length L of a side channel. Part of the energy of the standing water wave is subsequently converted to electricity by a piston-type wave energy converter 326 deployed at the closed end of one of the side branches. Another conventional type of wave energy converter (i.e. paddle, plunger or floating body type) can also be implemented. One or more passive or active vortex generators 338 can be deployed in the vicinity of the side channel (cavity) openings in order to enhance vortex shedding at the leading edge. A passive vortex generator can employ two- or three-dimensional surface modifications (protrusions) at the side wall(s) or the bottom of the main channel. In the case of active vortex generation, a wave maker or a device providing fluid injection/suction can be deployed in conjunction with a wave transducer 350.

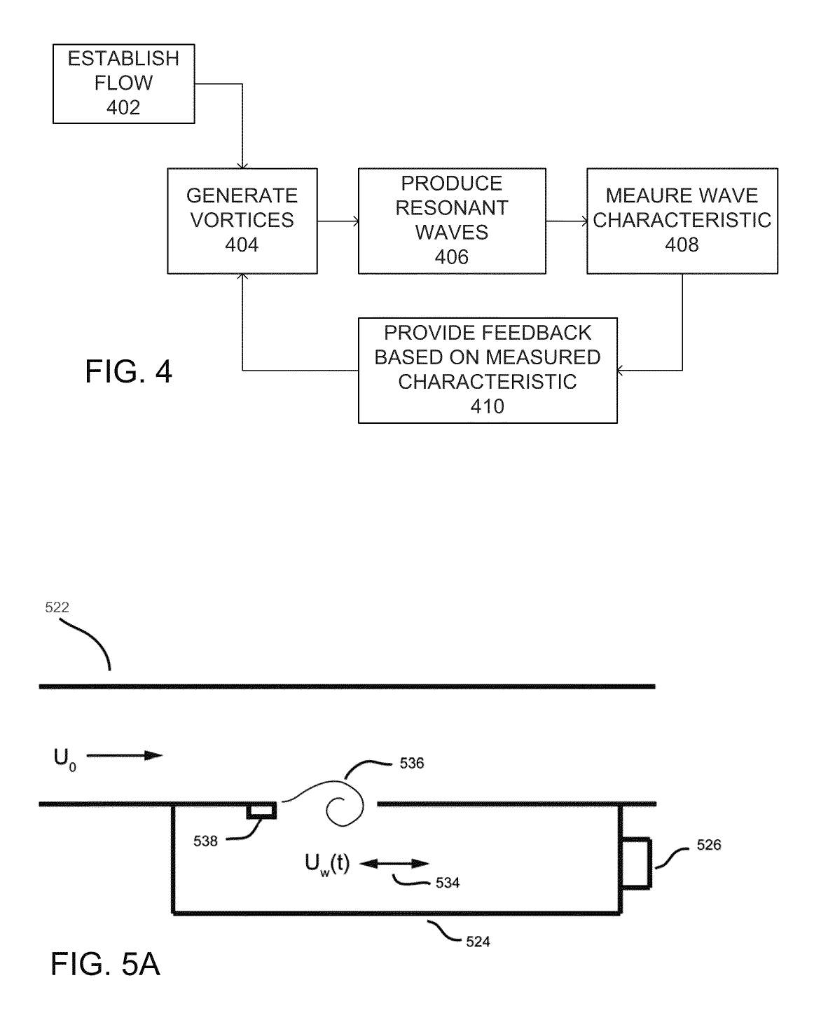

FIG. 4 is schematic diagram of a representative method 400 of controlling flow so as to enhance or otherwise promote (or reduce) vortex shedding. In particular, FIG. 4 illustrates operation of a control loop which can be implemented in order to enhance the vortex shedding used to produce vortices at the leading edge. A flow channel is provided at 402, and the flow is coupled to a vortex generator at 404 so as to produce resonant waves at 406. At 408, a wave transducer is situated to measure frequency and amplitude of the standing wave in the side channel (cavity), and this information is transmitted through a feedback loop at 410 to control operation of an active vortex generator at the appropriate phase with respect to the resonant standing wave at 402. By selecting suitable feedback phases and amplitudes, vortex generation can be enhanced or suppressed.

FIGS. 5A-5D illustrate a number of other embodiments. In these embodiments, one or more deep cavities or side branches 524, are located on at least one side of a main channel 522 and can be either parallel or perpendicular to the axis of the main channel, or oriented as some other angle with respect to the axis of the main channel 522. Water inflows with the characteristic velocity U₀ and causes vortices 536 to form and in turn generates a standing wave 534 in the cavities or side branches 524. Part of the energy of the standing water wave is subsequently converted to electricity by a piston-type wave energy converter 526 or other energy convertor deployed at the closed end or other location of one of the side branches. Another conventional type of wave energy converter (i.e. paddle, plunger or floating body type) can also be used. The wave resonators in all embodiments of the device can be deployed in a series or parallel arrangement, if desired.

The water surface in the side branches tends to oscillate at a natural frequency of the resonator if it is excited by the unsteady flow along the opening of the side branches. Two coaxial side branches 324 shown in FIG. 3 represent a rectangular basin of length 1=2L+D and width W.

A simple quarter wave resonator model can be used to describe the response of each branch of the coaxial resonator. According to this model, only the waves that are odd multiples of a quarter wavelengths can be excited inside the side branches. For n=1, one quarter of the characteristic wavelength of the resonator spans the depth of each side branch, and thus one half of a wavelength is completed across both side branches. Similarly, for n=3 and n=5, three quarters of a wavelength and five quarters of a wavelength span each side branch respectively. It should be noted that in reality, the lower modes contain most energy and are, therefore, generally preferred. In particular, it has been shown for an analogous flow-acoustic resonator that the first resonant mode is excited first, as the velocity in the main duct is gradually increased from a low value [13]. 13. Oshkai, P., et al., Acoustic Power Calculation in Deep Cavity Flows: A Semi-Empirical Approach. Journal of Fluids Engineering, 2008. 130(5).

FIG. 5A illustrates a single side channel 524 extending in a common direction with the main channel. FIG. 5B illustrates serial connected side channels 524, wherein each of the side channels is situated on the same side of the main flow channel. FIG. 5C illustrates oppositely situated side channels 524 that extend in a common direction with the main channel 522. FIG. 5D illustrates a representative curved side channel 524, but side channels of other shapes can be used, such as multi-segmented channels, serpentines, arcs, or other convenient shapes. In FIGS. 5B-5D, representative placements of the vortex generator 538 and wave energy convertor 526 are also shown. Wave energy convertors 526 are conveniently situated to permit superior power extraction at locations associated with peak side channel wave oscillations.

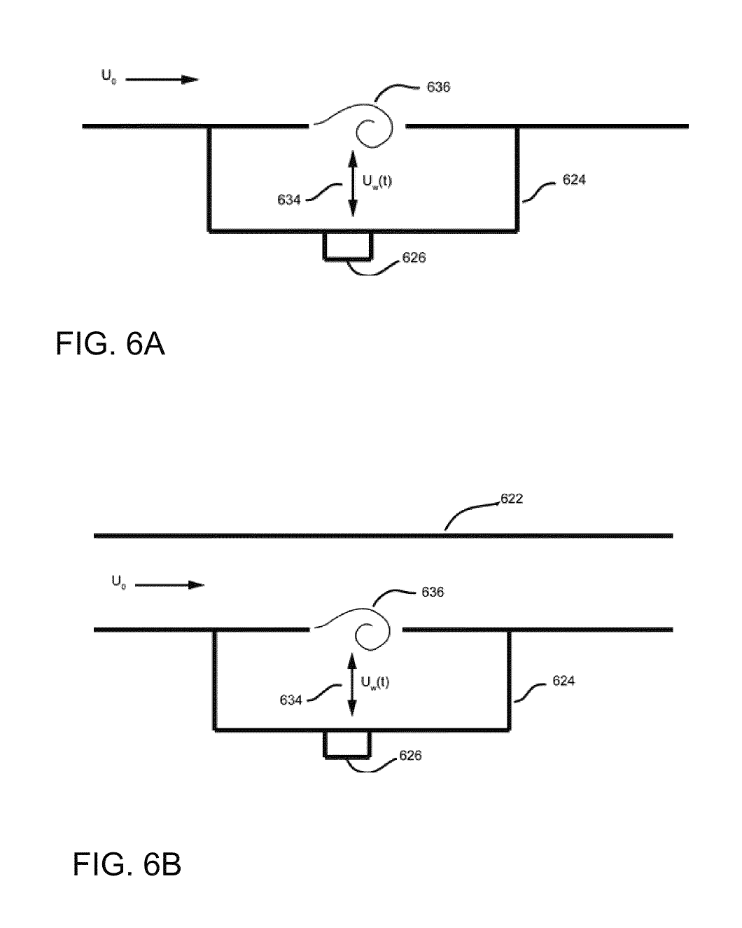

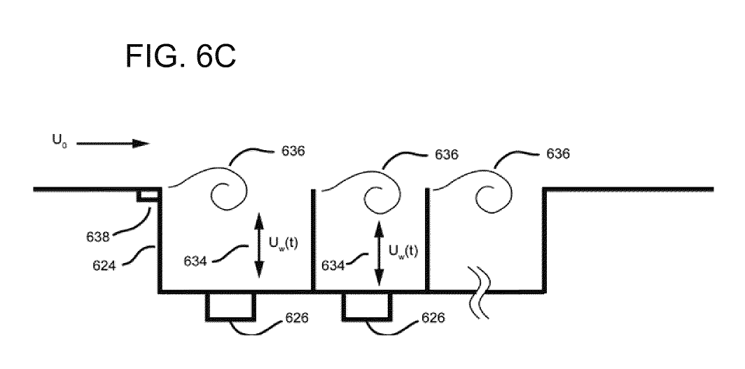

FIGS. 6A-6C illustrate wave energy power generation systems based on side channels configured as Helmholtz resonators. In this arrangement, the cavity or an estuary is connected to the main flow channel or a large body of water by a relatively narrow opening (mouth of the resonator). The fluid in the mouth of the resonator oscillates in the transverse direction with respect to the flow in the main channel. FIG. 6A illustrates a system based on a single side channel 624 coupled to a fluid reservoir having a flow associated with a flow velocity, U₀ and configured to generate at least one vortex 638 at a side channel opening. A wave energy convertor 626 is situated opposite the side channel opening to produce electrical power in response to fluid oscillations in the side channel 624. FIG. 6B illustrates an energy convertor having a single sided side channel 624 that is situated along a main channel 622, but otherwise similar to the configuration of FIG. 6A. FIG. 6C illustrates a series of adjacent side channels situated along a main flow direction. As shown in FIG. 6, the side channels include adjacent openings and the edges of the multiple side channels adjacent the main flow channel are configured to produce a plurality of vortices 636. One or more or all of the side channels can be provided with one or more wave energy convertors 626, and the number of side channels can be selected as convenient. but in other examples can be situated on opposite sides along parallel but offset axes. FIG. 5C illustrates oppositely situated side channels 524 that extend in a common direction with the main channel 522. FIG. 5D illustrates a representative curved side channel 524, but side channels of other shapes can be used, such as multi-segmented channels, serpentines, arcs, or other convenient shapes. Wave energy convertors are conveniently situated to permit superior power extraction at locations associated with peak side channel wave oscillations.

In the examples disclosed above, side channels are shown as parallel or perpendicular to a main channel, but in other examples, side channels can be arranged so along any direction with respect to a main channel. Side channel opening edges are configured to produce vortices that generate free surface standing waves. Such openings can be provided with addition features to enhance vortex generation as preferred.

In view of the many possible embodiments to which the principles of the disclosure may be applied, it should be recognized that the illustrated embodiments are only preferred examples and should not be taken as limiting the scope. Rather, the scope of the invention is defined by the following claims. We therefore claim all that comes within the scope and spirit of the appended claims.

### References

The following references provide additional information as described above, and each is incorporated herein by reference.

I claim:

1. An apparatus, comprising:
a side channel fluidically coupled to a main fluid flow and situated to receive flow oscillations based on the main fluid flow, the side channel having a length, width, and depth selected based on a flow oscillation frequency associated with the main fluid flow; and
a wave energy converter coupled to the side channel, wherein the wave energy converter is configured to generate electricity in response to flow oscillation in the side channel.

2. The apparatus of claim 1, further comprising a main flow channel configured to receive the main fluid flow.

3. The apparatus of claim 1, further comprising a wave transducer responsive to at least one of frequency and amplitude of free-surface wave in the side channel associated with the flow oscillations; and
a vortex generator coupled to the wave transducer and configured to enhance vortex shedding from a leading edge of the side channel opening based on the wave surface transducer response.

4. The apparatus of claim 3, wherein the vortex generator is an active vortex generator.

5. The apparatus of claim 4, wherein the main flow channel is a flow cavity.

6. The apparatus of claim 1, wherein the side channel includes a side channel opening into the main fluid flow and configured to generate flow oscillation at at least one edge of the side channel opening.

7. The apparatus of claim 1, wherein the main fluid flow is along a main flow axis, and the side channel is substantially parallel to the main flow axis.

8. The apparatus of claim 1, wherein the main fluid flow is along a main flow axis, and the side channel is substantially perpendicular to the main flow axis.

9. The apparatus of claim 7, wherein the side channel comprises two sections of substantially the same length oppositely situated with respect to the main flow axis.

10. The apparatus of claim 8, wherein the side channel comprises two sections of substantially the same length oppositely situated with respect to the main flow axis.

11. The apparatus of claim 1, wherein the side channel has a length selected so as to produce standing fluid waves in response to the main fluid flow.

12. The apparatus of claim 1, wherein the wave energy converter is a piston, paddle, plunger or floating body type wave energy convertor.

13. The apparatus of claim 2, further comprising a plurality of adjacent side channels along the main flow channel.

14. A method, comprising:
directing a fluid flow to an opening of a side channel;
establishing standing fluid waves in the side channel based on the fluid flow;
coupling a power convertor to the standing fluid waves in the side channel so as to produce electrical power.

15. The method of claim 14, further comprising establishing the standing waves based on vortex generation associated with the fluid flow at an opening into the side channel.

16. The method of claim 15, wherein the vortex generation is associated with edges of the opening into the side channel.

17. The method of claim 15, further comprising detecting at least one standing wave characteristics and controlling vortex generation based on the at least one standing wave characteristic.

18. The method of claim 17, wherein the at least one standing wave characteristic is a phase characteristic.

19. The method of claim 18, further comprising controlling vortex generation based on the phase characteristic so as to generate vortices having a phase suitable to enhance standing wave amplitude.

20. The method of claim 14, wherein the fluid flow is directed through a main channel coupled to the side channel at the opening of the side channel, and configured so that the main channel is parallel to the side channel or perpendicular to the side channel, and the

21. A method, comprising:
receiving a fluid flow;
producing at least one vortex in the received fluid flow;
generating oscillating surface waves based on the at least one vortex; and
coupling the oscillating surface waves to a wave-energy convertor.
